(19) United States
(12) Patent Application Publication
(10) Pub. No.: US 2008/0024010 A1
(43) Pub. Date: Jan. 31, 2008

(54) AUTOMATIC AUXILIARY LIGHTING UNIT

(76) Inventor: John Romano, Crown Point, IN (US)

Correspondence Address: HARTMAN & HARTMAN, P.C., 552 EAST 700 NORTH, VALPARAISO, IN, 46383, US

(21) Appl. No.: 11/831,578

(22) Filed: Jul. 31, 2007

Related U.S. Application Data
(60) Provisional application No. 60/820,864, filed on Jul. 31, 2006.

(51) Int. Cl. H02J 7/00; H02J 7/02; H05B 37/02

(52) U.S. Cl. 307/66

(57) ABSTRACT

A lighting unit having a battery-powered auxiliary light source that is automatically powered in the event of a power outage. The lighting unit can be an integral portion of a lamp, configured as an add-on to an existing lamp, or configured as a standalone light source. The lighting unit includes a device for rectifying AC power supplied to the unit to generate DC power, a battery and a device for charging the battery from the AC power, a relay powered by the DC power and with input contacts electrically connected to the battery, and at least one LED light source electrically connected to output contacts of the relay. The relay is configured so that it interrupts current flow from the battery to the LED light source when the DC power is supplied to the relay as a result of AC power being supplied to the rectifying device, and the relay automatically enables current flow from the battery to the LED light source when the DC power to the relay is interrupted as a result of AC power to the rectifying device being interrupted.

### CROSS REFERENCE TO RELATED APPLICATIONS

This application claims the benefit of U.S. Provisional Application No. 60/820,864, filed Jul. 31, 2006, the contents of which are incorporated herein by reference.

### BACKGROUND OF THE INVENTION

The present invention generally relates to light sources and, more particularly, to an automatic auxiliary lighting unit suitable for providing users with a light source in the event of a power outage.

The most common artificial light sources currently available for use in residential and commercial buildings are incandescent lamps (including halogen lamps), fluorescent lamps, and high-intensity discharge (HID) lamps. More recently, solid state lighting (SSL) such as LED (light-emitting diode) lamps have become sufficiently powerful to be considered as artificial light sources.

Regardless of what type of light source is used, electricity is required for its operation. In the event of a power interruption to wired light sources due to a power outage, candles, lanterns, flashlights, and other types of backup lighting are often used to provide lighting until electrical power is restored. Unless previously set aside in a location easily accessible in the dark, a search for backup lighting after a power failure can be difficult and hazardous.

### BRIEF SUMMARY OF THE INVENTION

The present invention provides a lighting unit having a battery-powered auxiliary light-emitting device that is automatically powered in the event of a power outage. The lighting unit can be an integral portion of a lamp, configured as an add-on to an existing lamp, or configured as a standalone light source.

The lighting unit includes a component for delivering AC power to the unit, a device for rectifying the AC power to generate DC power, a battery, a device for charging the battery from the AC power, a relay powered by the DC power and with input contacts electrically connected to the battery, and at least one LED light source electrically connected to the output contacts of the relay. The relay is configured so that it interrupts current flow from the battery to the LED light source when the DC power is supplied to the relay as a result of AC power being supplied to the rectifying means, and the relay automatically enables current flow from the battery to the LED light source when the DC power to the relay is interrupted as a result of AC power to the rectifying means being interrupted.

A significant advantage of this invention is that the lighting unit avoids the hassles and dangers associated with a sudden power outage that eliminates all wired light sources in a residence. Furthermore, the lighting unit is versatile, convenient and easy to use, lightweight yet durable in design, and provides a user with a convenient light source in the event of a power outage.

Other objects and advantages of this invention will be better appreciated from the following detailed description.

### BRIEF DESCRIPTION OF THE DRAWINGS

FIGS. 1 and 2 are block and schematic diagrams, respectively, of a lamp equipped with an automatic auxiliary lighting unit in accordance with an embodiment of this invention.

FIG. 3 schematically represents the lighting unit of FIGS. 1 and 2 as an add-on to an existing lamp.

FIG. 4 schematically represents the lighting unit of FIGS. 1 and 2 as an integral feature of a lamp.

FIG. 5 schematically represents the lighting unit of FIGS. 1 and 2 as a standalone light source.

### DETAILED DESCRIPTION OF THE INVENTION

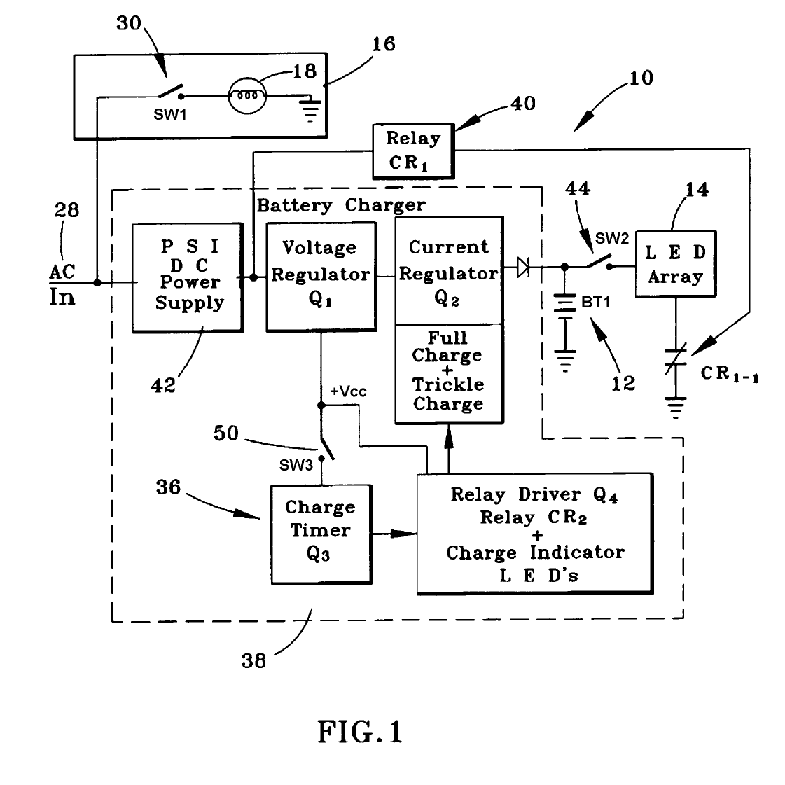

FIGS. 1 and 2 schematically represent the most basic components preferred for the operation and use of an automatic auxiliary lighting unit 10 of this invention. The lighting unit 10 comprises a battery 12 and a battery-operated LED (light-emitting diode) light source 14. The lighting unit 10 is represented as adapted for use with a lamp 16, such as a desk lamp or floor lamp, equipped with a light source 18, such as a conventional AC-powered incandescent bulb or a fluorescent bulb, though other lamp configurations and bulb configurations are possible.

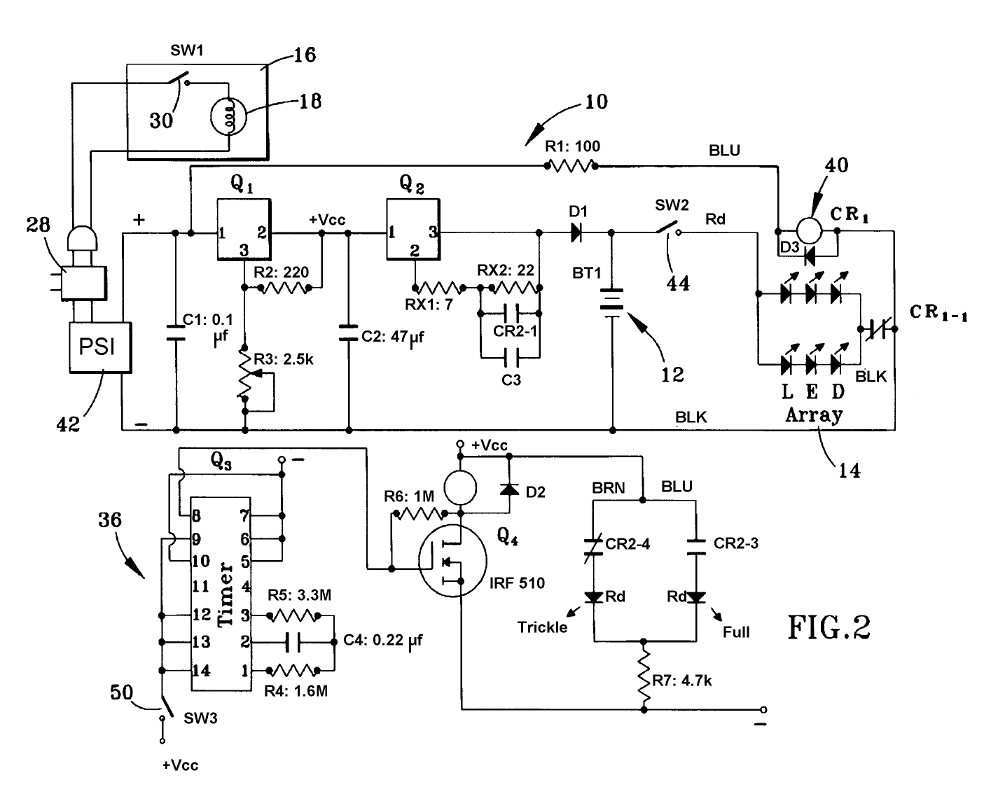

Three configurations for implementation of the lighting unit 10 with or without the lamp 16 are represented in FIGS. 3 through 5. Because of similarities between the embodiments of FIGS. 3 through 5, consistent reference numbers are used in the Figures to identify functionally similar structures. FIG. 3 generically represents a suitable configuration for the lamp 16 as including a lamp pole 20 supported by a base 22, with its light source 18 located near the upper end of the lamp pole 20. A lamp shade 24 is preferably positioned over the light source 18 to direct light produced by the source 18, such as downward. The lamp 16 is further provided with a conventional power cord 26, by which electric power can be supplied from a power source 28 (FIGS. 1 and 2), such as an AC outlet, through the base 22, lamp pole 24, and a switch (SW1) 30 to the light source 18.

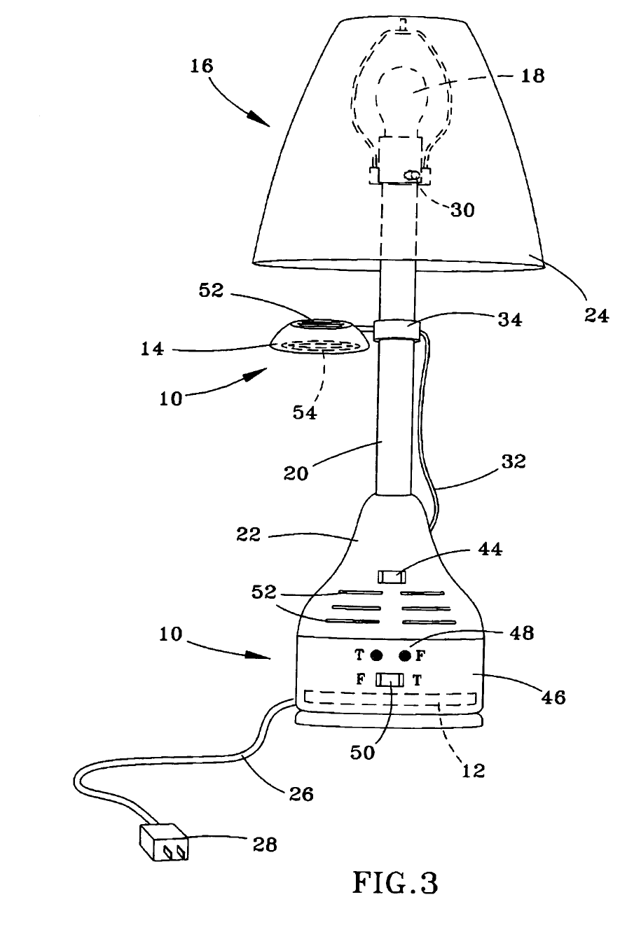

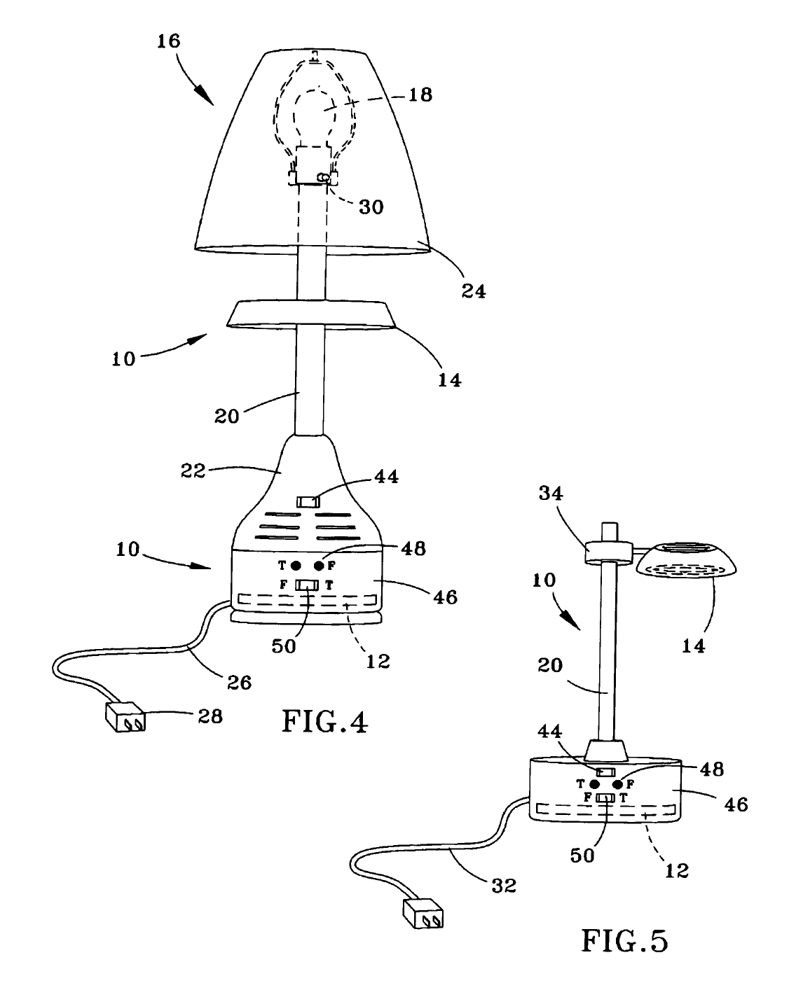

The lighting unit 10 is shown in FIG. 3 as an add-on, in which the LED light source 14 is secured by a clamp 34 to the lamp pole 20 of the lamp 16, a base housing 46 secured to the base of the lamp base 22, and a cord 32 to supply power from the base housing 46 to the unit 10. The unit 10 can also be structurally and ornamentally integrated into the original construction of the lamp 16, as represented in FIG. 4. Furthermore, FIG. 5 represents the unit 10 configured for use as a standalone lighting device that, similar to FIGS. 3 and 4, may entail mounting the unit 10 to a pole 20 on a base housing 46, with a power cord 32 supplying power to the unit 10 through the pole 20 and base housing 46.

In each of the above embodiments, the unit 10 is represented as oriented so that the LED light source 14 faces downward from the underside of the unit 10. The LED light source 14 may be made up of LED's of any suitable number, type, color, power, and configuration, a nonlimiting example being an array of six individual LED's that together consume about 60 mA to produce light at an illuminance level of about 235 foot-candles (about 2500 lux). A lens 54 can be mounted to the underside of the light source 14 to magnify the intensity of the LED's. As is conventional, the LED's of the LED light source 14 are powered with DC current. In order to keep power nearly constant with variations in supply and LED characteristics, a preferred power supply for the LED light source 14 would be capable of supplying an almost constant current. However, an approximation of a constant current source can be achieved by connecting the LED light source 14 to the battery 12. The battery 12 is preferably located within a separate base housing 46, as shown in FIGS. 3 through 5, though it is foreseeable that the battery 12 could be located within the lamp base 22 or any other suitable (preferably concealed) location. An advantage of its location at the bottom of the base housing 46 is convenient access to the battery 12 for replacement. The battery 12 may be a conventional primary battery, though is preferably rechargeable, such as a 9.6 volt 1600 mA·hr nickel-cadmium (NiCd) battery or a nickel-metal hydride (Ni-MH) battery.

The LED light source 14 receives current from the battery 12 as a result of the action of a relay (CR1) 40 and a switch (SW2) 44, which are preferably located on the light source 14 and the base housing 46, respectively. The switch 44 has switch positions labeled “automatic” and “off” to control the operation of the LED light source 14. When the switch 44 is in the “automatic” position, the operation of the lighting unit 10 is as described below. When the switch 44 is placed in the “off” position, the connection between the battery 12 and LED light source 14 is interrupted, and the LED light source 14 is not illuminated under any conditions. As is conventional, the relay 40 has a coil (not shown) for controlling the positions of input and output contacts. The relay coil is supplied with DC power, such as from an unregulated DC power supply 42 (e.g., 12 volts, 500 mA) that rectifies AC power obtained from the same power source 28 that supplies power to the lamp bulb 18. Contacts (CR1-1) of the relay 40 are configured to be normally closed so that when AC power is supplied from the power source 28 to the unit 10, the relay contacts CR1-1 are held open and current from the battery 12 is not supplied through the relay 40 to the LED light source 14. When AC power is lost for whatever reason, the relay 40 de-energizes and the contacts CR1-1 automatically close. If the switch 44 is in its “automatic” position, current is conducted from the battery 12 to the LED light source 14, causing them to be illuminated. The relay 40 is shown as having a current limit resistor (R1) and a fly-back diode (D3) to damp inductive spikes generated by the relay 40.

As represented in FIGS. 1 and 2, the battery (BT1) 12 is rechargeable by a battery charging unit 38, which is powered by the power source 28 and supplies a recharging current as required and while AC power is available. The battery charging unit 38 includes the DC power supply 42, a voltage regulator (Q1), and a current regulator (Q2), as represented in FIGS. 1 and 2. The voltage regulator Q1 sets the regulated DC voltage of the unit 38. In FIG. 2, the voltage regulator Q1 operates with a bypass capacitor C1, a filter capacitor C2, a program resistor R2, and a voltage adjustment potentiometer R3. Exemplary but nonlimiting values for these electrical components (as well as other electrical components of the charging unit 38) are indicated in FIG. 2. The current regulator Q2 operates to provide either a full or trickle charge output to the battery 12 through the use of a resistor RX1 alone to provide a full charge current or in series with a second resistor RX2 to provide a trickle charge current. A preferred full charge current is about 160 mA, while a preferred trickle charge current is about 40 mA, though lesser and greater charge currents are foreseeable. A reverse polarity protector diode (D1) is positioned between the current regulator Q2 and the battery 12 to prevent the battery 12 from being charged in reverse.

Charging of the battery 12 can be controlled with a timing circuit 36 preferably located within the base housing 46. The timing circuit 35 includes a charge timer (Q3) whose operation is controlled by a switch (SW3) 50 and whose status can be indicated with charge indicator LED's 48 on the unit 10 or on the base housing 46. In FIGS. 3 through 5, the charge indicator LED's 48 are located on the base housing 46 and indicate whether the charging unit 38 is delivering a full charge (“F”) or trickle charge (“T”) to the battery 12.

The charge timer Q3 is employed to establish a full charge time for the battery 12. The charge timer Q3 sets the full charge time with a capacitor (C4) and two resistors (R4 and R5), the second (R5) having a resistance value of about twice that of the first (R4), which together set the output frequency of the charge timer Q3. The embodiment of FIG. 2 provides for a full charge time of about fourteen hours, though it should be understood that longer and shorter full charge times are possible.

When the switch 50 is in the “trickle charge” position, the charge timer Q3 is disabled and only a trickle charge current is delivered to the battery 12. When the switch 50 is in the “full charge” position, the charge timer Q3 initiates a timed charging sequence when power is first applied to the charging unit 38 or restored following a power loss (during which the relay 40 was de-energized). When a timed charging sequence is initiated by the charge timer Q3, a second relay (CR2) is energized through a relay driver circuit (Q4), closing normally open contacts (CR2-1) to short out the resistor RX2 of the current regulator Q2, such that a full charge current is delivered to the battery 12. After a predetermined time period, the charge timer Q3 times out and de-energizes the relay CR2, putting the resistor RX2 back into the charging circuit of the current regulator Q2 so that a trickle charge is delivered to the battery 12. A capacitor (C3) protects the relay contacts CR2-1 from spikes, and a fly-back diode (D2) damps inductive spikes from the relay CR2. A self-biasing resistor (R6) stabilizes the relay driver circuit Q4, and current to the charge indicator LED's 48 is delivered through a current limit resistor (R7).

In view of the heat generated by the components within the light source 14 and the base housing 46, vents 52 can be provided in the light source 14 and the lamp base 22, and/or any other effective locations that will promote the dissipation of heat.

While the invention has been described in terms of specific embodiments, it is apparent that other forms could be adopted by one skilled in the art. For example, the physical configuration of the unit 10 could differ from that shown, and various materials could be use to manufacture the various components of the unit 10. Therefore, the scope of the invention is to be limited only by the following claims.

1. An automatic auxiliary lighting unit for providing light in the event of a power outage, the unit comprising:
means for delivering AC power to the unit;
means for rectifying the AC power to generate DC power;
a battery and means for charging the battery from the AC power;
a relay powered by the DC power and with input contacts electrically connected to the battery; and
at least one LED light source electrically connected to output contacts of the relay;
wherein the relay is configured so that the relay interrupts current flow from the battery to the LED light source when the DC power is supplied to the relay as a result of AC power being supplied to the rectifying means, and the relay automatically enables current flow from the battery to the LED light source when the DC power to the relay is interrupted as a result of AC power to the rectifying means being interrupted.

2. The automatic auxiliary lighting unit according to claim 1, wherein the unit is configured as an add-on to an existing lamp.

3. The automatic auxiliary lighting unit according to claim 2, further comprising means for clamping the unit to a lamp pole of the existing lamp.

4. The automatic auxiliary lighting unit according to claim 1, wherein the unit is structurally and ornamentally integrated into a lamp.

5. The automatic auxiliary lighting unit according to claim 1, wherein the unit is configured as a standalone light source.

6. The automatic auxiliary lighting unit according to claim 1, wherein the battery charging means is adapted to provide a full charge and a trickle charge to the battery.

7. The automatic auxiliary lighting unit according to claim 6, further comprising lights adapted to indicate whether the battery charging means is providing a full charge or a trickle charge to the battery.

8. The automatic auxiliary lighting unit according to claim 6, further comprising timing means for controlling whether the battery charging means provides a full charge or a trickle charge to the battery.

9. The automatic auxiliary lighting unit according to claim 1, further comprising a switch having a first position that enables current flow from the battery to the LED light source and a second position that prevents current flow from the battery to the LED light source.

10. The automatic auxiliary lighting unit according to claim 1, wherein the unit is secured to a lamp, the unit further comprising a base housing supporting the lamp, the base housing containing the rectifying means, the battery, and the battery charging means.

11. The automatic auxiliary lighting unit according to claim 10, wherein the battery charging means is adapted to provide a full charge and a trickle charge to the battery.

12. The automatic auxiliary lighting unit according to claim 11, further comprising lights on the base housing and adapted to indicate whether the battery charging means is providing a full charge or a trickle charge to the battery.

13. The automatic auxiliary lighting unit according to claim 11, further comprising timing means located within the base housing for controlling whether the battery charging means provides a full charge or a trickle charge to the battery.

14. The automatic auxiliary lighting unit according to claim 10, further comprising a switch having a first position that enables current flow from the battery to the LED light source and a second position that prevents current flow from the battery to the LED light source.
